(19) United States
(12) Patent Application Publication
(10) Pub. No.: US 2017/0323106 A1
(43) Pub. Date: Nov. 9, 2017

(54) SYSTEM AND METHOD FOR ENCRYPTING DATA IN ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/599,096

(22) Filed: May 18, 2017

Related U.S. Application Data
(63) Continuation-in-part of application No. 15/361,934, filed on Nov. 28, 2016.
(60) Provisional application No. 62/338,547, filed on May 19, 2016.
(60) Provisional application No. 62/260,553, filed on Nov. 29, 2015.
(60) Provisional application No. 62/261,355, filed on Dec. 1, 2015.

(51) Int. Cl. G06F 21/60; H04L 9/14; H04L 29/06

(52) U.S. Cl. CPC G06F 21/602; H04L 63/0428; H04L 9/14; G06Q 2220/10

(57) ABSTRACT

A system and method for encrypting data in an electronic document. The method includes analyzing the electronic document determine at least one transaction parameter for the electronic document, wherein the electronic document includes at least partially unstructured data; creating a template for the analyzed electronic document, wherein the template is a structured dataset including the determined at least one transaction parameter; determining, based on the template, at least one portion of the electronic document to be encrypted; and customizing the electronic document by encrypting the determined at least one portion.

### CROSS-REFERENCE TO RELATED APPLICATIONS

This application claims the benefit of U.S. Provisional Application No. 62/338,547 filed on May 19, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to encrypting data, and more particularly to encrypting data in electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

As businesses increasingly rely on technology to manage data related to operations such as invoice and purchase order data, suitable systems for properly managing and collecting data have become crucial to success. Particularly for large businesses, the amount of data utilized daily by businesses can be overwhelming. Accordingly, manual review and collection of such data is impractical, at best.

Further, businesses must often report expenses. For example, expenses may need to be reported to obtain refunds such as, e.g., value-added tax refunds for purchases made abroad. Reporting these expenses may require submitting documents evidencing transactions such as invoices and receipts. However, such evidencing documents often contain sensitive information that may need to be redacted such as employee names, medical information, trade secrets, etc. Particularly when redacting medical information, it may be improper or illegal for the business to review the sensitive information. Accordingly, businesses typically hire external reviewers to manually review and redact sensitive information. Such manual review and redaction is expensive, time-consuming, and subject to human error that could result in violating laws.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for encrypting data in electronic documents. The method comprises: analyzing the electronic document determine at least one transaction parameter for the electronic document, wherein the electronic document includes at least partially unstructured data; creating a template for the analyzed electronic document, wherein the template is a structured dataset including the determined at least one transaction parameter; determining, based on the template, at least one portion of the electronic document to be encrypted; and customizing the electronic document by encrypting the determined at least one portion.

Certain embodiments disclosed herein also include a non-transitory computer readable medium having stored thereon instructions for causing a processing circuitry to perform a process, the process comprising: analyzing the electronic document determine at least one transaction parameter for the electronic document, wherein the electronic document includes at least partially unstructured data; creating a template for the analyzed electronic document, wherein the template is a structured dataset including the determined at least one transaction parameter; determining, based on the template, at least one portion of the electronic document to be encrypted; and customizing the electronic document by encrypting the determined at least one portion.

Certain embodiments disclosed herein also include a system for creating historical records based on at least partially unstructured electronic documents. The system comprises: a processing circuitry; and a memory, the memory containing instructions that, when executed by the processing circuitry, configure the system to: analyzing the electronic document determine at least one transaction parameter for the electronic document, wherein the electronic document includes at least partially unstructured data; creating a template for the analyzed electronic document, wherein the template is a structured dataset including the determined at least one transaction parameter; determining, based on the template, at least one portion of the electronic document to be encrypted; and customizing the electronic document by encrypting the determined at least one portion.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a document encrypter according to an embodiment.

FIG. 3 is a flowchart illustrating a method for encrypting data in electronic documents according to an embodiment.

FIG. 4 is a flowchart illustrating a method for creating a dataset based on at least one electronic document according to an embodiment.

FIG. 5 is a flowchart illustrating a method for generating encrypted tags based on electronic document data according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for encrypting data in electronic documents. In an embodiment, a dataset is created based on an electronic document. A template of transaction attributes is created based on the electronic document dataset. The template may be a structured dataset created based on at least partially unstructured data generated via machine imaging of the electronic documents.

Based on the created template, it is determined whether the electronic document includes data to be encrypted and what data, if any, is to be encrypted. Determining whether to encrypt and what data to be encrypted may be based on one or more encryption rules defining predetermined sensitive data to be encrypted. Upon determining that at least a portion of data in the document is to be encrypted, at least one encrypted tag is generated for the determined portion. The electronic document is customized using the generated at least one encrypted tag. The customized electronic document may be stored in a storage, sent to an enterprise system, and the like.

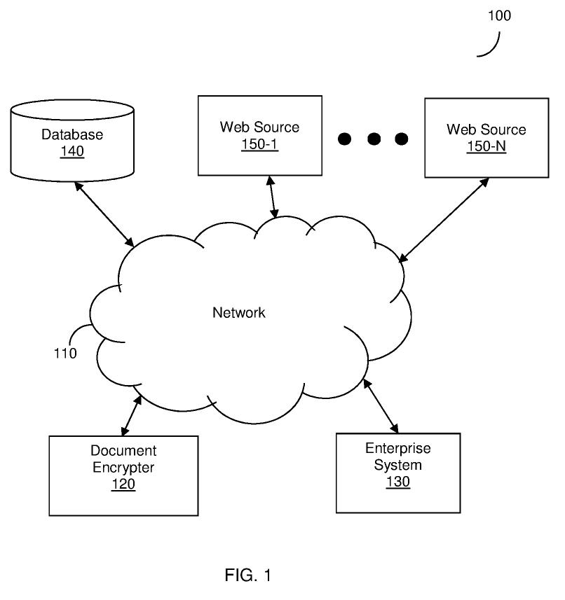

FIG. 1 shows an example network diagram 100 utilized to describe the various disclosed embodiments. In the example network diagram 100, a document encrypter 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to transactions involving the enterprise or representatives of the enterprise as well as data related to the enterprise itself. The enterprise may be, but is not limited to, an enterprise such as a business whose employees may purchase goods and services pursuant to their roles and responsibilities. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing a scan of an invoice, a text file, a spreadsheet file, etc.), encryption rules defining data to be encrypted and the like. Each electronic document may show, e.g., an invoice, a tax receipt, a purchase number record, and the like. Data included in the electronic documents is at least partially unstructured such that the data may be structured, semi-structured, unstructured, or a combination thereof. The structured or semi-structured data may be in a format that is not recognized by the document encrypter 120 and, therefore, may be treated as unstructured data.

The encryption rules may include or otherwise define a list of template fields. The list of template fields may indicate one or more fields of templates including transaction parameters to be encrypted. The list may be predetermined based on, e.g., requirements of the enterprise. As a non-limiting example, fields to be encrypted may include “employee name,” “employee social security number,” “medical procedure,” “passport number,” “employee condition,” and the like. The encryption rules may be, but are not limited to, enterprise encryption rules utilized internally by an enterprise, regulatory authority encryption rules defining information required to be encrypted by regulation, legal authority encryption rules defining information required to be encrypted by law, combinations thereof, and the like.

The electronic document may be related to a transaction involving the enterprise. Consequently, the electronic document may indicate at least expenses incurred by the enterprise during the transaction and other information related thereto. As a non-limiting example, an electronic document may indicate a type of good or service purchased (e.g., a hotel stay, medical expenses, etc.), a time of the transaction, a price per unit, a quantity, a buyer, a supplier (e.g., a seller or a manufacturer), supplier information (e.g., name, merchant registration number, etc.), combinations thereof, and the like.

The database 140 stores customized electronic documents created by the document encrypter 120. The customized electronic documents are at least partially redacted via encryption of one or more portions of data therein.

Each of the web sources 150 may include information utilized for encrypting data. In an example implementation, each web source 150 may include sets of encryption rules, lists of parameters to be encrypted (e.g., lists of fields for which transaction parameters included in one of the listed fields of the template should be encrypted), a combination thereof, and the like. Utilizing encryption rules and lists from the web sources 150 may allow for utilizing updated encryption rules and lists as they change due to, for example, changes in law, changes in regulations, changes in business best practices, and the like. Alternatively or collectively, the encryption rules, lists of parameters, or both, may be included in the enterprise system 130 as noted above. Utilizing rules and lists from both the enterprise system 130 and from one or more of the web sources 150 allows for meeting both internal (i.e., of the enterprise) and external (e.g., of a regulatory authority) requirements for redacting and encrypting information. The web sources 150 may include, but are not limited to, tax authority servers, accounting servers, and the like.

In an embodiment, the document encrypter 120 is configured to create templates based on transaction parameters identified using machine vision on at least partially unstructured electronic documents indicating information related to transactions involving an enterprise. In a further embodiment, the document encrypter 120 may be configured to retrieve the electronic documents from, e.g., the enterprise system 130. Alternatively or collectively, electronic documents may be received from client devices (not shown) utilized by employees or other representatives of the enterprise. Based on the created templates, the document encrypter 120 is configured to determine data to be encrypted.

Each template is a structured dataset including the identified transaction parameters for a transaction. The transaction parameters indicate information related to the transaction that are indicated in the electronic document such as, but not limited to, a type of good or service purchased (e.g., a hotel stay, medical treatment, etc.), a time of the transaction, a price per unit, a quantity, a buyer (e.g., as identified via name, identification number such as social security number or a passport number, etc.), a supplier (e.g., a seller or a manufacturer), supplier information (e.g., name, merchant registration number, etc.), and the like.

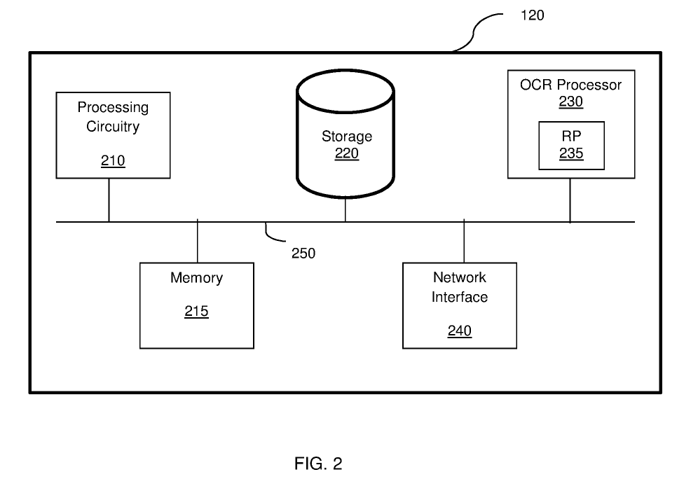

In an embodiment, the document encrypter 120 is configured to create datasets based on at least partially unstructured electronic documents including data at least partially lacking a known structure (e.g., unstructured data, semi-structured data, or structured data having an unknown structure). In some implementations, an unstructured document for which a dataset is created may be an image (e.g., a scan of an invoice). To this end, in a further embodiment, the document encrypter 120 may be further configured to utilize optical character recognition (OCR) or other image processing to determine data in the electronic document. The document encrypter 120 may therefore include or be communicatively connected to a recognition processor (e.g., the recognition processor 235, FIG. 2). Based on the datasets, the document encrypter 120 is configured to create the templates.

In another embodiment, the document encrypter 120 may be further configured to validate the electronic document based on the template. The validation may include, but is not limited to, determining whether the electronic document is complete and accurate.

The electronic document may be determined to be complete if, for example, one or more predetermined reporting requirements is met (e.g., for a purchase, relevant requirements may include types of goods or services purchased, total price, quantity, supplier, etc.).

The electronic document may be determined to be accurate based on data stored in at least one external source. The at least one external source may include, but is not limited to, one or more web sources or other data sources (not shown). As a non-limiting example, a merchant server of a merchant who was the seller in a transaction may be queried for metadata related to the electronic document associated with the transaction, and the metadata obtained via the query may be compared to data of the template for the electronic document. For example, the metadata obtained via the query may include a price of the transaction, a transaction identifier, and the like, which may be compared to data in corresponding fields of the template created for the transaction.

In an embodiment, the document encrypter 120 is configured to determine, based on the created template, at least one portion of the electronic document to be encrypted. The determination may be based on one or more sets of encryption rules defining data to be encrypted, which may be obtained from, for example, the enterprise system 130, the web sources 150, or a combination thereof, as described herein above.

In some embodiments, if no portion of the electronic document is determined as requiring encryption, the electronic document may be stored (e.g., in the database 140) without encrypting any portion thereof.

As a non-limiting example, if an employee of an enterprise purchases accommodations in a hotel during a business trip, details related to the employee's stay such as the employee's name, credit card number, and the like, may not be allowed to be shared with the enterprise by the hotel. In such a case, one of the web sources 150 may be a server of the hotel including encryption rules for electronic documents to be shared with an enterprise. As another non-limiting example, personal information or non-business related expenses may be forbidden from reporting when seeking a VAT reclaim as indicated in encryption rules of the enterprise system 130, a merchant server among the web sources 150, and the like. As yet another non-limiting example, certain personal information (e.g., name, medical condition, treatment sought) in a receipt for medical expenses may not be shared due to medical privacy laws as indicated in encryption rules of the web sources 150 such as a hospital server, a regulatory authority server, and the like.

In an embodiment, the document encrypter 120 is configured to identify at least one transaction parameter to be encrypted from among the transaction parameters in the template. In a further embodiment, the at least one transaction parameter to be encrypted may be identified using encryption rules defining types of parameters to be encrypted. In yet a further embodiment, the identified transaction parameters are transaction parameters included in fields of the template indicated as requiring encryption in the encryption rules. In an example implementation, the encryption-requiring fields defined in the encryption rules may include fields related to personal identifiers, non-business expenses, both, and the like. As a non-limiting example, the encryption rules may indicate that the field “medical procedure” may include transaction parameters requiring encryption.

In an embodiment, the document encrypter 120 is configured to customize the electronic document so as to redact sensitive or otherwise unnecessary information therein. To this end, in a further embodiment, the document encrypter 120 is configured to generate an encrypted data item for each identified transaction parameter. In yet a further embodiment, each encrypted data item may be an encrypted tag generated based on a predetermined index value. The predetermined index values may be stored in a storage such as, for example, the database 140. Each encrypted tag may be an identifier of the encrypted information such that use of the encrypted tags allows for removing the sensitive data while allowing the encrypted data to be identified for purposes such as searching and viewing the electronic document. In an embodiment, customizing the electronic document may include replacing each transaction parameter to be encrypted with one of the generated encrypted tags.

In an embodiment, the document encrypter 120 may be configured to store the customized electronic document in, e.g., the database 140. The database 140 may be configured to thereafter receive a query indicating a personal identifier, and to provide a stored customized electronic document based on the received query.

In another embodiment, the document encrypter 120 may be configured to automatically seek a VAT reclaim based on the customized electronic document.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the document encrypter 120 according to an embodiment. The document encrypter 120 includes a processing circuitry 210 coupled to a memory 215, a storage 220, and a network interface 240. In an embodiment, the document encrypter 120 may include an optical character recognition (OCR) processor 230. In another embodiment, the components of the document encrypter 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to encrypt data in electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in at least partially unstructured data sets. Specifically, in an embodiment, the OCR processor 230 is configured to identify at least characters in the unstructured data. The identified characters may be utilized to create a dataset including data required for analyzing transactions and generating recommendations based thereon.

The network interface 240 allows the document encrypter 120 to communicate with the enterprise system 130, the database 140, or both, for purposes such as, for example, obtaining electronic documents, storing transaction historical records, obtaining transaction historical records, sending recommendations, and the like.

It should be understood that the embodiments described herein are not limited to the specific architecture illustrated in FIG. 2, and other architectures may be equally used without departing from the scope of the disclosed embodiments.

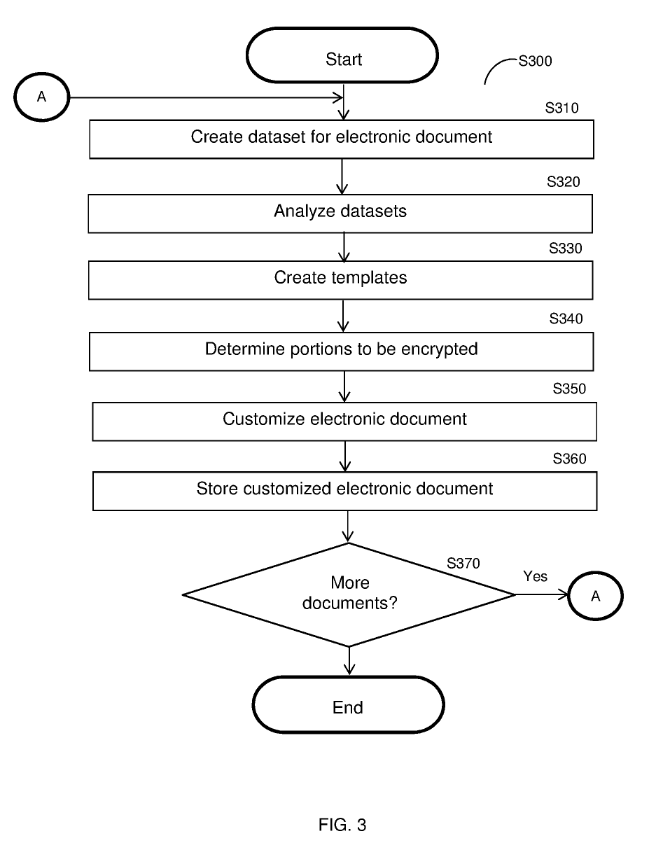

FIG. 3 is an example flowchart 300 illustrating a method for encrypting data in an electronic document according to an embodiment. In an embodiment, the method is performed by the document encrypter 120. The electronic document may illustrate information related to a transaction and, to this end, may include one or more portions indicating information such as personal or otherwise non-business related information (e.g., employee name, social security number, passport number, medical history or treatment, etc.) that may be required to be redacted by enterprise or third party rules. The sensitive information may need to be redacted to, e.g., maintain employee privacy, comply with legal requirements, and the like.

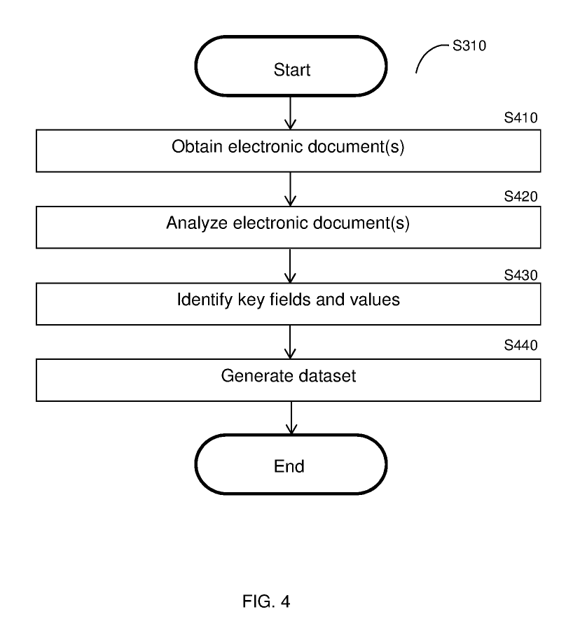

At S310, a dataset is created for the electronic document. The electronic document indicates at least partially unstructured data of a transaction and may include, but is not limited to, unstructured data, semi-structured data, structured data with structure that is unanticipated or unannounced, or a combination thereof. In an embodiment, S310 may further include analyzing the electronic document using optical character recognition (OCR) to determine data in the electronic document, identifying key fields in the data, identifying values in the data, or a combination thereof. Creating datasets based on at least partially unstructured electronic documents is described further herein below with respect to FIG. 4.

At S320, the dataset is analyzed. In an embodiment, analyzing the dataset may include, but is not limited to, determining transaction parameters such as, but not limited to, at least one enterprise identifier (e.g., a consumer enterprise identifier, a merchant enterprise identifier, or both), information related to the transaction (e.g., a date, a time, a price, a type of good or service sold, etc.), personal information (e.g., employee name, social security number, passport information, medical records, etc.), or a combination thereof.

At S330, a template is created based on the analyzed dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, the created template is analyzed to determine at least one portion of the electronic document to be encrypted. In an embodiment, S340 includes identifying at least one transaction parameter included in the created template. In a further embodiment, the at least one transaction parameter to be encrypted may be identified based on a set of encryption rules. The set of encryption rules defines data to be encrypted, and may include, but is not limited to, a list of fields. Transaction parameters in fields of the created template matching the listed fields may be identified as requiring encryption.

In some embodiments, if no transaction parameters are identified as requiring encryption, S340 may result in a null value. The null value may indicate that no portion of the electronic document requires encryption and, therefore, the electronic document is not to be customized.

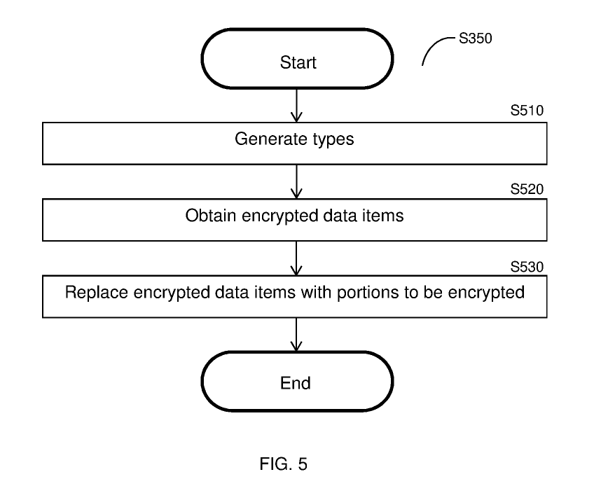

At S350, the electronic document is customized with respect to the determined at least one portion. In an embodiment, S350 includes replacing each determined portion with an encrypted data item. The encrypted data items may be encrypted tags, where each encrypted tag identifies a type of sensitive or otherwise redacted data. In a further embodiment, S350 may include generating the encrypted tags based on index values stored in, e.g., a database. In another embodiment, each encrypted tag may replace one of the identified transaction parameters. Customizing an electronic document is described further herein below with respect to FIG. 5.

At S360, the customized electronic document may be sent for storage in, e.g., a database. Storing the customized electronic document allows for secure (i.e., by withholding sensitive or otherwise unnecessary information) access to the customized electronic document by, e.g., an enterprise, a third party (e.g., a tax authority), and the like. The encrypted tags may be utilized for searching and organizing of customized electronic documents with respect to particular identifying information without revealing the identifying information itself.

At S370, it is determined if data in additional electronic documents are to be encrypted and, if so, execution continues with S310; otherwise, execution terminates.

Encrypting a plurality of electronic documents allows for batch processing of incoming electronic documents that are scanned or otherwise submitted by employees of an enterprise. Further, use of the templates allows for efficient creation of the transaction historical records when the electronic documents utilized to create the transaction historical records are at least partially unstructured.

As a non-limiting example, an image showing a scan of an invoice for a reservation of a 3-night hotel stay is received. The invoice indicates information including hotel name, location, date, price, and a customer name “John Smith.” Data in the image is determined and utilized to create a structured template including a field “customer name” containing the transaction parameter “John Smith.” Encryption rules for an enterprise seeking to obtain a VAT reclaim for the hotel stay transaction indicate that transaction parameters in a field “customer name” are to be encrypted. Accordingly, the name “John Smith” in the “customer name” field of the template is identified as requiring encryption. An encrypted tag is generated and the name “John Smith” in the image is replaced with the encrypted tag, thereby customizing the image. The customized image is stored in a database. Upon receiving a query including the hotel name of the invoice, the customized image may be provided, thereby allowing access to information of the invoice without revealing the personal information indicated by the “customer name” field.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

FIG. 5 is an example flowchart S350 illustrating a method for customizing an electronic document according to an embodiment. In an embodiment, the method may be executed based on portions of the electronic document determined to require encryption (e.g., as determined in S340, FIG. 3).

At S510, a type of each portion of the electronic document requiring encryption is determined. In an embodiment, each determined type may be a personal identifier or a non-business expense. If a further embodiment, each determined type may further indicate whether the portion is an alphabetical portion or a numerical portion (e.g., if a transaction parameter is an alphabetical text string such as a name or condition, or if the transaction parameter is a numerical string such as an identification number or credit card number).

At S520, based on the determined types, an encrypted data item may be obtained for each portion of the electronic document requiring encryption. In an embodiment, S520 includes generating an encrypted tag with respect to each determined type and based on index values stored in, e.g., a database. The index values assigned to different types of data, thereby allowing for recognition of the type of data indicated in an electronic document without revealing such data when the electronic document is accessed by, e.g., an enterprise representative. As a non-limiting example, the transaction parameter “broken arm” may be determined to be an alphabetical string personal identifier and, accordingly, a tag “Personal Information” is generated based on an index value assigned to alphabetical string personal identifiers.

At S530, each determined portion is replaced with the corresponding encrypted data item, thereby creating a customized electronic document having sensitive data replaced with encrypted data.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for encrypting data in an electronic document, comprising:
analyzing the electronic document determine at least one transaction parameter for the electronic document, wherein the electronic document includes at least partially unstructured data;
creating a template for the analyzed electronic document, wherein the template is a structured dataset including the determined at least one transaction parameter;
determining, based on the template, at least one portion of the electronic document to be encrypted; and
customizing the electronic document by encrypting the determined at least one portion.

2. The method of claim 1, wherein determining the at least one transaction parameter for the electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

4. The method of claim 1, wherein determining the at least one portion of the electronic document to be encrypted further comprises:
identifying, based on at least one set of encryption rules, at least one transaction parameter of the electronic document to be encrypted, wherein each set of encryption rules defines data requiring encryption.

5. The method of claim 4, encrypting the determined at least one portion further comprises:
determining a type of each transaction parameter to be encrypted; and
identifying an index value assigned to each determined type;
generating, for each transaction parameter to be encrypted, an encrypted tag based on the respective index value; and
replacing each transaction parameter to be encrypted with the respective encrypted tag.

6. The method of claim 5, wherein the determined type is at least one of: a personal identifier, and a non-business expense.

7. The method of claim 6, wherein the at least one set of encryption rules includes at least one of: a set of enterprise encryption rules, at least one set of regulatory authority encryption rules, and at least one set of legal authority encryption rules.

8. The method of claim 1, wherein each determined portion to be encrypted indicates at least one of: a name of a person, a social security number, a passport number, a medical condition, and a medical treatment.

9. The method of claim 1, wherein analyzing the electronic document further comprises:
analyze, by an optical character recognition processor, the electronic document to identify data in the electronic document, wherein the at least one transaction parameter of the electronic document is determined based on the identified data of the electronic document.

10. A non-transitory computer readable medium having stored thereon instructions for causing a processing circuitry to perform a process, the process comprising:
analyzing an electronic document determine at least one transaction parameter for the electronic document, wherein the electronic document includes at least partially unstructured data;
creating a template for the analyzed electronic document, wherein the template is a structured dataset including the determined at least one transaction parameter;
determining, based on the template, at least one portion of the electronic document to be encrypted; and
customizing the electronic document by encrypting the determined at least one portion.

11. A system for encrypting data in an electronic document, comprising:
a processing circuitry; and
a memory, the memory containing instructions that, when executed by the processing circuitry, configure the system to:
analyze the electronic document determine at least one transaction parameter for the electronic document, wherein the electronic document includes at least partially unstructured data;
create a template for the analyzed electronic document, wherein the template is a structured dataset including the determined at least one transaction parameter;
determine, based on the template, at least one portion of the electronic document to be encrypted; and
customize the electronic document by encrypting the determined at least one portion to be encrypted.

12. The system of claim 11, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

14. The system of claim 11, wherein the system is further configured to:
identify, based on at least one set of encryption rules, at least one transaction parameter of the electronic document to be encrypted, wherein each set of encryption rules defines data requiring encryption.

15. The system of claim 14, wherein the system is further configured to:
determine a type of each transaction parameter to be encrypted; and
identify an index value assigned to each determined type;
generate, for each transaction parameter to be encrypted, an encrypted tag based on the respective index value; and
replace each transaction parameter to be encrypted with the respective encrypted tag.

16. The system of claim 15, wherein the determined type is at least one of: a personal identifier, and a non-business expense.

17. The system of claim 16, wherein the at least one set of encryption rules includes at least one of: a set of encryption rules of an enterprise, and at least one set of encryption rules of a regulatory authority.

18. The system of claim 11, wherein each determined portion to be encrypted indicates at least one of: a name of a person, a social security number, a passport number, a medical condition, and a medical treatment.

19. The system of claim 11, further comprising:
an optical character recognition processor, wherein the system is further configured to:
analyze, by the optical character recognition processor, the electronic document to identify data in the electronic document, wherein the at least one transaction parameter of the electronic document is determined based on the identified data of the electronic document.
